(19) United States
(12) Patent Application Publication
(10) Pub. No.: US 2024/0010761 A1
(43) Pub. Date: Jan. 11, 2024

(54) Hydrocarbon Resins Prepared by Sequential Hydrogenation and Direct Decoloration

(71) Applicant: ExxonMobil Chemical Patents Inc., Baytown, TX (US)

(72) Inventors: Jose M. Vargas, Baton Rouge, LA (US); Keith C. Gallow, Kingwood, TX (US); Thomas R. Barbee, Kingwood, TX (US); Alison M. Miller, Houston, TX (US); Yuan-Ju Chen, Houston, TX (US)

(21) Appl. No.: 18/035,020

(22) PCT Filed: Oct. 5, 2021
(86) PCT No.: PCT/US21/53492

§ 371 Date: May 2, 2023

(51) Int. Cl. C08F 8/04; B01J 27/049

(52) U.S. Cl. CPC C08F 8/04; B01J 27/049

(57) ABSTRACT

Methods for resin hydrogenation and decoloration may comprise reacting a resin mixture with a sulfided bimetallic catalyst and excess hydrogen under conditions effective to form a hydrogenated resin mixture, the resin mixture comprising an oligomerized reaction product of at least one polymerizable monomer containing an olefinic unsaturation and a solvent; providing the hydrogenated resin mixture directly to a noble metal catalyst; and reacting the hydrogenated resin mixture in the presence of the noble metal catalyst under conditions effective to form a decolorized resin mixture. Decolorized resin compositions comprising a decolorized resin mixture formed in accordance with the foregoing may have a yellowness index of about 10 or below, as measured by ASTM E313.

### CROSS REFERENCE TO RELATED APPLICATIONS

This application claims the priority benefit of U.S. Ser. No. 63/126,180, filed Dec. 16, 2020, which is incorporated herein by reference.

### FIELD

The present disclosure relates to processes for making hydrocarbon resins by direct decoloration following hydrogenation, such as by processing distillates derived from petroleum cuts that have undergone further steam cracking, followed by oligomerization and hydrogenation of the oligomers.

### BACKGROUND

Hydrocarbon resins derived from petroleum distillates have a number of industrial uses such as, for example, hot melt adhesive formulations, reinforcing agents, polymer intermediates, tackifiers, and contact adhesives. The production of hydrocarbon resins often involves at least two stages: thermal or catalytic oligomerization of monomers to form a crude resin, followed by hydrogenation of the resulting crude resin mixture to remove the remaining olefins and impurities. Hydrogenation improves resin stability and prevents a number of downstream issues. For example, prior to hydrogenation, residual olefins are reactive and can change physical properties during storage by undergoing polymerization and crosslinking, thereby forming resins that are no longer suitable for their intended use. In addition, residual olefins can cause issues during downstream polymerization applications, often forming insoluble organic deposits (often referred to as coke) within the reactor, thereby generating a pressure drop that can force reactor shutdown and maintenance delays in some instances.

Impurities formed during oligomerization also include “color bodies,” which may

include conjugated olefinic species that may impart undesirable off-colors to a resin mixture. Examples of color bodies may include, but are not limited to, trace impurities such as indigo, anthraquinone, alizarin, juglone, and the like. To improve appearance, hydrogenation catalysts can also be used to saturate color bodies and similar entities, particularly in a separate decoloration step following initial hydrogenation. Hydrogenation of olefins, decoloration, and aromatic saturation are three separate reactions, and catalysts optimized for one reaction are often not optimized for the other reactions. Moreover, increasing a catalyst's activity for one reaction may result in a loss of selectivity towards the other reactions. For example, increasing a catalyst's olefin saturation activity may also increase the catalyst's aromatic saturation activity. Excessive hydrogenation of aromatics may reduce a resin's compatibility with certain aromatic polymers, such as polystyrene, thus rendering the resin unsuitable for certain desired applications. Therefore, successful resin processing may strike a balance between these three reactions.

Hydrotreating processes for the hydrogenation, dearomatization, desulfurization, and denitrogenation of hydrocarbon compounds, including hydrocarbon resins and other compositions such as petroleum fuels, white oils, lubricating oil additives, and the like, are well known and practiced industrially. In particular, these processes are often conducted in fixed bed reactors using a heterogeneous catalyst, such as catalysts comprising a catalytically active metal supported on a metal oxide such as alumina.

Many of the foregoing hydrotreating processes use multiple catalysts in series to achieve a desired process result, with each catalyst performing a different function. The different types of catalysts can be contained within the same catalyst bed or can be spread across different beds and reactors. In these cases, the catalyst metal types and process conditions are relatively similar across each catalyst bed. Examples of using multiple catalysts to accomplish a single process objective include: a demetallization catalyst in series with a hydrotreating catalyst, different types of hydrotreating catalysts in series, or a hydrotreating catalyst in series with a sour stage hydrocracking catalyst. In these examples, bimetallic base metal catalysts, including multimetallic base metal catalysts, may be used, such as those comprising CoMo, NiMo, NiW, or NiMoW on alumina, and the stages may operate at similar temperatures and pressures.

In some instances, it has been found advantageous to use two-stage hydrotreating processes, where the catalyst and process conditions are significantly different between the first and second stages. Examples of two-stage hydrotreating processes with different catalysts or process conditions include, but are not limited to. diolefin-saturator/hydrotreating, hydrotreating/sweet-stage hydrocracking, and hydrotreating/hydrofinishing. For example, hydrotreating often uses bimetallic base metal catalysts such as CoMo, NiMo, or NiW on alumina at temperatures up to about 850° F. (˜454° C.), while hydrofinishing may employ noble metal catalysts on acidic zeolitic substrates at temperatures up to about 570° F. (˜299° C.) to maximize the amount of aromatic molecules that become saturated with hydrogen. The term “bimetallic catalyst” includes catalysts containing at least two metals and is inclusive of multimetallic catalysts as well. When retention of aromaticity is desirable, such noble metal catalysts and process conditions may prove unsuitable for conducting hydrofinishing.

While two-stage and multi-stage processes are typically more efficient than are one-stage processes, incorporating multiple stages may increase system complexity while also increasing costs for equipment and maintenance. The use of multiple catalysts also carries the risk of catalyst poisoning impacting one or more stages, particularly for noble metal catalysts used in many second-stage hydrofinishing processes. In such cases, one or more intermediate purification stages may be conducted in stages to remove potential poisons, such as sulfur compounds, again resulting in increased process complexity and cost. In addition, two-stage processes often may utilize separate hydrogen recycle streams to prevent cross-contamination between stages, which may otherwise lead to poisoning of the noble metal catalyst, again resulting in excessive process complexity.

### SUMMARY

In some aspects, embodiments of the present disclosure are directed to methods for preparing hydrocarbon resins comprising: reacting a resin mixture with a sulfided bimetallic catalyst and excess hydrogen under conditions effective to form a hydrogenated resin mixture, the resin mixture comprising an oligomerized reaction product of at least one polymerizable monomer containing an olefinic unsaturation and a solvent; providing the hydrogenated resin mixture directly to a noble metal catalyst; and reacting the hydrogenated resin mixture in the presence of the noble metal catalyst under conditions effective to form a decolorized resin mixture.

In another aspect, embodiments of the present disclosure are directed to decolorized resin compositions comprising: a hydrogenated resin mixture formed from an oligomerized reaction product of at least one polymerizable monomer containing an olefinic unsaturation, wherein the hydrogenated resin mixture has a yellowness index of about 10 or below, as measured by ASTM E313.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a graph of yellowness index as a function of temperature for a hydrocarbon resin produced in accordance with Example 1.

FIGS. 2-4 are graphical depictions of X-ray photoelectron spectroscopy (XPS) data for catalyst systems employed in Example 1.

FIG. 5 is a graph of yellowness index as a function of time on stream produced in accordance with Example 2.

FIG. 6 is a graph of yellowness index as a function of temperature in Example 3.

FIG. 7 is a graph of aromatics saturation (conversion) as a function of temperature in Example 3.

FIG. 8 is a graph of color conversion as a function of aromatics conversion in Example 3.

FIG. 9 is a graph of color conversion as a function of aromatics conversion in Example 3 for a comparative sample decolorized with a porous Pt/Pd catalyst.

FIGS. 10 and 11 are graphs of aromatic content as a function of time on stream for experimental and comparative samples in Example 4.

FIG. 12 is a graph of softening point as a function of time on stream for experimental and comparative samples in Example 4.

FIGS. 13 and 14 are graphs showing initial coloration and aged coloration (as yellowness index), respectively, for experimental and comparative samples in Example 4.

### DETAILED DESCRIPTION

The present disclosure relates to hydrocarbon resins, specifically methods and catalysts suitable for conducting hydrogenation and decoloration of hydrocarbon resins. More particularly, the present disclosure relates to the removal of color from hydrocarbon resins using a sulfided bimetallic catalyst and a noble metal catalyst arranged in series, each having high catalytic activity and selectivity, without intermediate feed purification steps, which provides two-stage effectiveness with system complexity that is similar to single-stage processes. The two catalysts may afford hydrocarbon resins having improved color and promote high retention of aromaticity. Such hydrocarbon resins may exhibit improved color, as measured by ASTM E313, as compared to hydrocarbon resins produced by alternative hydrogenation and decoloration processes.

Prior hydrogenation and decoloration processes in hydrocarbon resin production have utilized single and multiple catalysts (e.g., a primary catalyst and a secondary catalyst). However, decoloration operations utilizing a secondary catalyst often employ a separate reactor operating at different temperature and pressure conditions from the reactor(s) containing the primary catalyst. In addition. hydroprocessing operations to promote hydrogenation and decoloration using multiple catalysts often incorporate intermediate purification stages to remove impurities and catalyst poisons, such as sulfur compounds, present in feedstocks or generated as reaction byproducts, that may otherwise foul and reduce the efficiency of downstream secondary catalysts that may be sensitive to poisons, particularly noble metal catalysts.

As demonstrated herein, two-stage hydrogenation and decoloration of a hydrocarbon resin may surprisingly be accomplished without performing intermediate purification of the reaction product between the first stage and the second stage. More specifically, a sulfided bimetallic hydrogenation catalyst and particular noble metal catalysts may be utilized in series under specified conditions to afford hydrogenated resin mixtures having an improved color profile, as well as good retention of aromaticity in some instances. More particularly, a hydrogenated resin mixture may be fed directly to the noble metal catalyst without undergoing intermediate purification to remove sulfur compounds, thereby providing the surprising result of maintaining catalytic activity without experiencing fouling or decreased performance. As such, the benefits of two-stage hydroprocessing may be realized through application of the present disclosure but without the complexities associated therewith.

Methods of the present disclosure may be used to hydrogenate and improve color of hydrocarbon resins to afford decolorized resin mixtures. Prior to hydrogenation, the hydrocarbon resins may include a number of aromatic moieties that contribute to beneficial physical properties, such as melting point, pour point, tackiness, chemical compatibility, and other physical and chemical properties. However, standard hydrogenation techniques may be non-selective and result in at least partial saturation of the aromatic moieties in addition to saturation of olefins and other resin impurities.

Methods of the present disclosure may feature catalysts and reaction conditions that afford colorless or reduced color hydrogenated resin mixtures, while substantially preserving the concentration of aromatic moieties therein. Up to about 10 wt. % aromatic moieties may be retained in the certain resin compositions described herein. The hydrogenation and decoloration reactions disclosed herein may exhibit enhanced production efficiency and comparatively low reaction temperatures, which may afford good energy efficiency and reduced operating costs. Hydrogenation and decoloration reactions may be conducted with suitable catalysts upon various hydrocarbon resins, referred to equivalently herein as “resin mixtures” or “hydrocarbon resin mixtures,” particularly those produced by the thermal or catalytic oligomerization of a steam cracked petroleum stream (such as naphtha). Petroleum streams can also be distilled prior to or after formation of a resin mixture. Hydrogenated resin mixtures having a desired color profile may be obtained through use of the disclosure herein. Resin mixtures and hydrogenated resin mixtures produced therefrom may further comprise an optional solvent and/or residual water from steam stripping, steam cracking, or other sources. Without being bound by any theory or mechanism, the presence of residual water is believed to aid in imparting sulfur tolerance during the decoloration reactions taking place upon the noble metal catalyst.

Methods of the present disclosure may comprise: reacting a resin mixture in the presence of a sulfided bimetallic catalyst and excess hydrogen under conditions effective to form a hydrogenated resin mixture, providing the hydrogenated resin mixture directly to a noble metal catalyst, and reacting the hydrogenated resin mixture in the presence of the noble metal catalyst in the presence of hydrogen and under conditions effective to form a decolorized resin mixture. Residual hydrogen may also be provided to the noble metal catalyst with the hydrogenated resin mixture. The term “hydrogenated” refers to both full hydrogenation and partial hydrogenation. The term “decolorized” refers to a decrease in a color of a resin mixture that has been treated using the disclosed methods of hydrogenation and decoloration relative to an untreated resin mixture (including non-hydrogenated or partially hydrogenated resin mixtures), and does not necessarily imply that the decolorized resin mixture is completely without color. Prior to hydrogenation, the resin mixture may comprise an oligomerized reaction product of at least one polymerizable monomer containing an olefinic unsaturation and optional solvent. Residual water may be present in the resin mixture as well. Suitable resin mixtures, sulfided bimetallic catalysts, and noble metal catalysts are provided hereinafter, as are suitable conditions to promote decoloration and retention of aromaticity.

Conditions effective to form a hydrogenated resin mixture and conditions effective to form a decolorized resin mixture may be the same as or different for each process stage. Preferably, hydrogenation of a resin mixture with a sulfided bimetallic catalyst may be performed by passing the resin mixture over the catalyst at a temperature of about 100° C. to about 320° C. and a pressure of about 6 MPa to about 27 MPa, or at a temperature of about 150° C. to about 350° C. and a pressure of about 2 MPa to about 30 MPa, or about 6 MPa to about 27 MPa. Preferably, the temperature may range from about 220° C. to about 350° C., or about 220° C. to about 260° C., or about 260° C. to about 300° C., or about 220° C. to about 300° C. Decoloration of the hydrogenated resin mixture with a noble metal catalyst may be performed by passing the hydrogenated resin mixture over the catalyst in the presence of hydrogen at a reaction temperature of about 100° C. to about 320° C. and a pressure of about 2 MPa to about 30 MPa, or about 6 MPa to about 27 MPa, or at a reaction temperature of about 150° C. to about 350° C. and a pressure of about 2 MPa to about 30 MPa, or about 6 MPa to about 27 MPa. Preferably, the temperature may range from about 220° C. to about 350° C., or about 220° C. to about 260° C., or about 260° C. to about 300° C., or about 220° C. to about 300° C. Hydrogen partial pressures up to about 200 atmospheres (˜20 MPa), may be used. Reaction pressures can be increased to an excess of 250 atmospheres (˜25 MPa) to promote a further reduction in residual resin unsaturation and/or color. Reaction times may range from about 2 minutes to about 2 hours of contacting time for each reaction stage. The hydrogen provided during decoloration in the second reaction stage may comprise residual hydrogen from the hydrogenation reaction of the first reaction stage and may be supplemented from an external source, if needed.

While the foregoing parameters are provided as guidelines, it is envisioned that modifications to these values are possible (e.g., ±10% or more) depending on application and coloration tolerance in the application. For example, if hydrogen partial pressure and total pressure are increased outside of the above ranges and the finished resin color remains constant, one would expect the values of the other process variables to change. As another non-limiting example, temperatures may be lowered, feed resin concentrations increased, or reactor space velocity [i.e., (total volumetric hydrocarbon resin feed rate)/(total catalyst volume in fixed bed)] may be increased. Pressure and/or temperature can also be increased as a means of reducing finished resin color and/or residual unsaturation as measured by standard techniques such as NMR, near-IR, or bromine number. The vol.:vol. ratio of the sulfided bimetallic catalyst to noble metal catalyst may also be altered in response to various application-specific product requirements.

After hydrogenating and decolorizing according to the disclosure herein, the decolorized resin mixture may be transferred from the reactor for downstream processing, such as flashing and separating to recover the decolorized resin mixture, promote sulfur and impurity removal from the final resin and/or recover solvent and excess hydrogen for recycling. In some embodiments, the decolorized resin mixture can be flashed and/or distilled in an oxygen free (or minimum oxygen) atmosphere to eliminate the solvent and any excess hydrogen. Decolorized resin mixtures can also be steam distilled to remove low molecular weight oily polymers, for example. Steam distillation of a decolorized resin mixture may be performed at 325° C. or below to minimize degradation of color and other properties of the decolorized resin mixture. In some embodiments, steam distillation can be performed at sub-atmospheric pressures.

Catalysts suitable for use in the present disclosure can be installed in a fixed bed reactor in which a feedstock comprising hydrocarbon resin mixture and hydrogen are passed over one or more stationary beds of catalyst. Such methods of the present disclosure may utilize a reactor design in which a sulfided bimetallic catalyst is arranged in a front position of the reactor, while a noble metal catalyst is arranged in a back or tail position. The sulfided bimetallic catalyst and the noble metal catalyst may remain separated from each other in the reactor. Suitable process configurations can also include the use of single reactors having multiple beds and/or the use of multiple reactors in series or parallel. That is, the sulfided bimetallic catalyst and the noble metal catalyst may be maintained in separate beds from one another, with a hydrocarbon resin feed contacting the sulfided bimetallic catalyst first in the various configurations and then being provided directly to the noble metal catalyst. Reactor inputs, including hydrocarbon resin mixtures and hydrogen, can be located at one or more stages within individual reactors and/or into each reactor in a multi-reactor configuration. The hydrocarbon resin mixture and hydrogen may be provided to the reactor in upflow or downflow mode. Methods in accordance with the present disclosure may be conducted in a batch fashion or in a continuous fashion, and can include partial or complete hydrogenation and/or decoloration. Additional hydrogen may also be added in front of a given catalyst bed as a cooling fluid to partially remove exothermic heat of reaction and/or to promote cooling of a subsequent fixed catalyst bed.

Hydrocarbon resin mixtures suitable for use in the present disclosure can include resins prepared from the thermal or catalytic oligomerization of petroleum distillate fractions, particularly petroleum distillate fractions that are steam cracked, such as those having boiling points within the range of about 20° C. to about 280° C. Particular hydrocarbon resin mixtures can include those prepared under thermal oligomerization conditions by forming a reaction product of one or more polymerizable monomers. Still more specific examples of suitable hydrocarbon resin mixtures may include those comprising a polymerizable monomer (in the form of an oligomerized reaction product) selected from dicyclopentadiene, methyldicyclopentadiene, styrene, methylstyrene, indene, the like, and any combination thereof. Individual hydrocarbon resins within the hydrocarbon resin mixture may have a weight average molecular weight ranging from about 300 g/mol to about 700 g/mol, or about 400 g/mol to about 650 g/mol.

Thermal oligomerization of one or more polymerizable monomers may be carried out in an oxygen-free atmosphere, usually at a temperature of about 160° C. to about 320° C., e.g., at about 250° C., at a pressure of about 10 atmospheres to 12 atmospheres (˜1.0 to 1.2 MPa), e.g., at about 10 atmospheres (˜1.0 MPa), and for a period of time of about 0.5 hours to about 9 hours, e.g., about 1 hour to about 4 hours. Thermal oligomerization may be conducted in a batch, semi-batch, or continuous operation mode.

Prior to contacting a sulfided bimetallic catalyst with the resin mixture and hydrogen according to the disclosure herein, the resin mixture can be diluted with a non-aromatic solvent. Non-aromatic solvents include saturated hydrocarbon solvents, such as naphtha and other distillates. Illustrative commercially available solvents such as EXXSOL™ or ISOPAR™ from ExxonMobil may be particularly suitable. Suitable solvents can be present in the resin mixture in a range of about 10 wt. % to about 80 wt. %, or about 40 wt. % to about 80 wt.%, or about 50 wt. % to about 75 wt. %, or about 55 wt. % to about 70 wt. %. The resin may comprise substantially the balance of the resin mixture. In some embodiments, resin mixtures can be diluted with a non-aromatic solvent (added or remaining from a resin-forming reaction) to afford a resin concentration ranging from about 20 wt. % to about 50 wt. %.

Catalysts suitable for use in the present disclosure may include catalyst systems comprising a sulfided bimetallic catalyst and a noble metal catalyst. Each catalyst may be selected and process conditions optimized to afford the various benefits discussed herein. For example, a catalyst system suitable for forming a decolorized resin mixture can include a large-pore sulfided bimetallic (e.g., NiW) catalyst as a primary catalyst capable of saturating olefins and other reactive species, followed by a noble metal catalyst as a secondary catalyst capable of decreasing the concentration of color bodies and other impurities within the hydrogenated resin mixture. Particular examples of noble metal catalysts, described in further detail below, may be especially sulfur-tolerant (sulfur-tolerant noble metal catalysts), which may obviate the need for intermediate purification steps between the catalyst stages, such as stripping sulfur from a process stream downstream of a sulfided bimetallic catalyst prior to contacting the noble metal catalyst. In addition, suitable catalyst systems may feature sulfided bimetallic catalysts and noble metal catalysts that may be utilized at similar temperatures and pressures, as well as utilizing overlapping process parameters, such that an independent reactor, stripper tower, or heat exchanger is not needed when processing a resin mixture and otherwise decreasing process complexity.

Each catalyst can differ by a number of factors, such as size, shape, metal type, metals loading, metal dispersion/crystallite size, support composition, surface treatment of the support, zeolite content, pore size, or other physical or chemical attributes. In some embodiments, two or more catalysts may function synergistically to decrease olefin concentration and color, while reducing the conversion of aromatic species in a hydrocarbon resin. Spheres, extrudates, and other catalyst shapes may be suitable for both types of catalyst.

The sulfided bimetallic catalyst and the noble metal catalyst may be disposed in a single reactor, such as a fixed bed reactor with the noble metal catalyst being physically separated from the sulfided bimetallic catalyst (e.g., with a screen) and located downstream from the sulfided bimetallic catalyst in the direction of reactor flow. Alternately, the resin mixture and hydrogen may be contacted with the sulfided bimetallic catalyst and the noble metal catalyst in multiple fixed bed reactors operating in series, optionally with some reactors operating in parallel. Other process configurations for the reaction promoted by either catalyst may include, for example, fluidized bed contacting conditions or slurry contacting conditions. Loop reactors or autoclave reactors may also be used in some embodiments.

In some embodiments, one or both of the sulfided bimetallic catalyst and the noble metal catalyst may be disposed in a catalyst bed comprising one or more diluent solids including oxides, carbides or other inert materials, such as aluminum oxide (alumina), mullite, silicon oxide, magnesium oxide, carbon, silicon carbide, and the like. In non-limiting examples, diluent solids may be added to decrease the amount of catalyst present in a fixed reactor volume, to promote flow redistribution, limit fouling, and/or to reduce the rate of heat generation or adsorption by exothermic or endothermic reactions, for example.

Sulfided bimetallic catalysts suitable for use in the disclosure herein may catalyze olefin saturation in the presence of hydrogen. Both catalysts containing two metals and catalysts containing more than two metals are encompassed by the term “bimetallic.” Thus, suitable bimetallic catalysts may include true bimetallic catalysts, as well as trimetallic catalysts and catalysts containing an even greater number of metals. Sulfided bimetallic catalysts can also saturate other reactive species that may impact the stability of hydrocarbon resins and create unwanted polymer byproducts that can cause reactor fouling and other issues. Sulfided bimetallic catalysts may include mixed base metals, such as a Group 9 or Group 10 metal, in combination with a Group 6 metal. Particular examples of suitable sulfided bimetallic catalysts may include, for example, dimetallic catalysts such as cobalt-molybdenum (CoMo), nickel-tungsten (NiW), nickel-molybdenum (NiMo), and the like. In some embodiments, multimetallic catalysts can be used, including trimetallic catalysts such as nickel-molybdenum-tungsten (NiMoW) and the like. Sulfided bimetallic catalysts can also include layered or mixed structures that incorporate various support materials, including oxides such as aluminum oxide, silicon oxide, and magnesium oxide, carbon, silicon carbide, and the like.

Sulfided bimetallic catalysts can be sulfided prior to use by contacting an unsulfided bimetallic catalyst with a suitable sulfur species, such as dimethyl disulfide (DMDS). Such sulfided bimetallic catalysts are referred to as being “pre-sulfided.” Bimetallic catalysts may be further sulfided in situ under similar activation conditions. The sulfiding process can include various methods such as: (1) commercial sulfidation in which 2.5 wt. % DMDS in a hydrocarbon solvent is contacted with a catalyst for about 4 hours at 250° C. or more (e.g., 40 hours at 330° C.) at 1 hr⁻¹ LHSV and 400-800 scf/bbl gas ratio ([volume of gas at STP/time]/[volume of liquid/time]); (2) pilot plant sulfidation in which 2.5 wt. % DMDS in a hydrocarbon solvent is contacted with a catalyst for 4 hours at 250° C. or more (e.g., 4 hours at 330° C.) at 1 hr⁻¹ LHSV and 200 gas ratio; or (3) commercial, pre-sulfidation processes in which gas-phase sulfidation of a catalyst is performed under a mixture of H₂S and H₂ at high temperatures (e.g., 400° C. to 450° C.) for 1 hour with H₂S/H₂>1 at sub-atmospheric pressures. For commercial, pre-sulfided catalysts, a hydrocarbon fluid may be absorbed into the sulfided catalyst pore volume to (1) reduce catalyst air sensitivity (passivation), and (2) to meet requirements for transporting as self-heating solid per DOT regulations. Bimetallic catalysts used herein may be at least pre-sulfided and optionally further sulfided in situ according to particular application-specific needs.

Suitable sulfided bimetallic catalysts can have a metals loading by weight percent (wt. %) of greater than about 0.25 wt. %, or greater than about 0.5 wt. %, or greater than about 1 wt. %, as measured relative to the weight of the support material. The loading of the first metal (Group 9 or Group 10 metal) to the second metal (Group 6 metal) in the sulfided bimetallic catalysts (e.g., CoMo, NiW, or NiMo) may include configurations where the first metal is loaded at about 0.5 wt. % to about 50 wt. % and the second metal is loaded at about 0.5 wt. % to about 30 wt. %, as measured relative to the weight of the support material. Accordingly, the first metal and the second metal may be present in the same or different amounts in the sulfided bimetallic catalysts.

Total pore volume of the sulfided bimetallic catalysts disclosed herein may range from about 0.4 cc/g to about 0.8 cc/g as determined by high pressure (60 kpsi) mercury intrusion porosimetry (ASTM D4284). The surface area of the sulfided bimetallic catalysts may range from about 50 m²/g to about 350 m²/g, or about 100 m²/g to about 250 m²/g, or about 150 m²/g to about 200 m²/g as determined by high pressure (60 kpsi) mercury intrusion porosimetry (ASTM D4284).

Suitable noble metal catalysts may be capable of catalyzing hydrogenation and color removal, particularly those capable of operating in the presence of compounds associated with fouling and poisoning of other noble metal catalysts, such as hydrogen sulfide and water. The sequential combination of a sulfided bimetallic catalyst and a noble metal catalyst may otherwise be particularly problematic without intermediate purification of the product stream produced therefrom, since sulfided bimetallic catalysts are known to produce sulfur compounds such as hydrogen sulfide under hydrogenation process conditions. The sulfur compounds may lead to rapid noble metal catalyst poisoning without intermediate purification of the product stream when using conventional noble metal catalysts. Advantageously, the noble metal catalysts described herein may operate without intermediate purification of a product stream comprising a hydrogenated resin mixture, thereby allowing the hydrogenated resin mixture to be transferred directly from the sulfided bimetallic catalyst to the noble metal catalyst for further decoloration and hydrofinishing.

The noble metal catalyst may comprise a support material in some embodiments. Particular noble metal catalysts having tolerance to sulfur poisons can include various layered configurations, such as pellicular heterogeneous catalysts (also referred to as eggshell or radially impregnated catalysts (“RIM catalysts”)). wherein the noble metal is located external to, or coated on, the support material as an external layer. Layered noble metal catalysts can include a noble metal coating upon the support material as an external layer, such that the support material is substantially free of noble metal. That is, the noble metal may be localized in an external layer surrounding a core of the support material, which may remain substantially free of noble metal or have a significantly reduced amount of noble metal compared to the external noble metal coating. The external metal coating comprising the noble metal may have a thickness of about 150 μm or less, or about 100 μm or less, or about 50 μm or less, such as about 10 μm to about 1 μm. Particular external metal coatings may have a thickness of about 100 micron or less, such as about 50 μm or less, or about 20 μm or less. Advantageously, the external metal coating affords a high effective concentration of noble metal in a small contacting area for promoting decoloration of the hydrogenated resin mixture. The high effective concentration and type of noble metal is believed to afford the tolerance to sulfur poisons in the disclosure herein, in addition to other factors such as the presence of water and reactor conditions (e.g., temperature and pressure). Pd is also believed to exhibit a higher tolerance to sulfur under these conditions than does Pt, for example.

Noble metal catalysts disclosed herein can be tuned to increase the selectivity of hydrogenation, decoloration, and aromatics saturation to tailor resin properties for suitability in a particular application, such as by modifying the thickness and/or surface area of the external layer particularly the external noble metal layer. Noble metal catalysts disclosed herein may include spherical particles having an overall diameter of about 2 mm or less, or about 1 mm or less, or about 0.5 mm or less. In some embodiments, noble metal catalysts can include extrudates having a cylindrical or semi-cylindrical profile having an overall length of about 5 mm or less, 4 mm or less, 3 mm or less, or 2 mm or less. Spheres may also be used. Noble metal catalysts can include an external noble metal layer having a thickness of about 100 μm or less, about 50 μm or less, about 10 μm or less, or about 5 μm or less, such as a noble metal layer thickness in a range of about 500 nm to about 150 μm, about 1 μm to about 50 μm, or about 55 μm to about 10 μm. In some embodiments, the surface area of the external noble metal catalyst layer as calculated by chemisorption of about 0.1 m²/g to about 1.000 m²/g. about 0.2 m²/g to about 900 m²/g, about 0.5 m²/g to about 800 m²/g, or about 0.5 m²/g to about 400 m²/g.

While the catalyst particle sizes and external layer thicknesses are presented as a guide, it is envisioned that the present methods can be performed using values above or below those stated without deviating from the present disclosure.

Suitable noble metal catalysts can incorporate one or more noble metals such as, for example, ruthenium, rhodium, palladium, silver, osmium, iridium, platinum, or gold. Palladium or platinum may be particularly suitable, preferably palladium. The noble metal catalysts may have a noble metal loading greater than about 0.1 wt. %, or greater than about 0.25 wt. %, or greater than about 0.5 wt. %, or greater than about 1 wt. %, as measured relative to the weight of the support material. In particular embodiments, the noble metal catalysts can include palladium or platinum at a platinum or palladium loading greater than about 0.1 wt. %, or greater than about 0.25 wt. %, or greater than about 0.5 wt. %, such as about 0.75 wt. % to about 1.0 wt. %, as measured relative to the weight of the support material.

Suitable support materials for the noble metal catalyst can include oxides such as aluminum oxide, silicon oxide, and magnesium oxide; carbon; porous carbon; silicon carbide, and the like. The support material defining the noble metal catalyst can be of any general shape, including extruded particles that can be spherical, cylindrical, or lobed in shape. For layered noble metal catalysts, the surface area of support material can be modified to increase or decrease the physical strength of the material. In some embodiments, the support material can have a surface area of about 3,000 m²/g or less, or about 1,000 m²/g or less, or about 750 m²/g or less, or about 500 m²/g or less. In some embodiments, noble metal catalysts can include a support material having a surface area in a range of about 50 m²/g to about 1,500 m²/g or about 50 m²/g to about 350 m²/g. In non-limiting examples, the noble metal coating may have a surface area ranging from about 0.1 m²/g to about 100 m²/g, or about 0.3 m²/g to about 40 m²/g.

Methods of the present disclosure may afford hydrogenated resin mixtures that are colorless or have reduced color compared to those produced by other processes for making colorless or reduced color petroleum resins. The retained aromaticity may be higher than in alternative processes, such as a retained aromaticity up to about 10%, up to about 15%, or up to about 20%. Following hydrogenation and decoloration, the decolorized resin mixture can be processed to remove at least a portion of solvent and excess hydrogen to yield a finished resin product. Finished resin products that are so-processed can be isolated as a liquid resin or undergo further processing into a solid form. Processing methods to produce resin solids may include one or more of casting, crushing after cooling, pastillation, prilling, flaking, and the like. For example, the decolorized resin mixture may be processed into pellets in any process configuration. Pellets formed from the decolorized resin mixture may be obtained in a variety of shapes including extruded particles that can be spherical, cylindrical, or lobed in shape.

Methods of the present disclosure can be used to hydrogenate and decolorize hydrocarbon resins while substantially maintaining the concentration and distribution of aromatic moieties in a decolorized resin mixture, as compared to the resin mixture from which the decolorized resin mixture was obtained. The concentration of aromatic moieties can be quantified using known methods such as determining the degree of unsaturation by NMR or bromine number (ASTM D1159). Near-IR measurements may also be utilized to determine the degree of unsaturation in some cases. In some embodiments, aromaticity loss in a hydrocarbon resin can be less than about 20%, less than about 15%, less than about 10%, or less than about 5%, as compared to the unhydrogenated resin mixture.

The extent of decoloration in the decolorized resin mixture prepared in accordance with the disclosure herein may be quantified by the yellowness index (YI) according to ASTM E313, for example, using a Hunterlab™ colorimeter with an illuminant observer combination of C/2. The higher the YI value, the more yellow the sample is. In some embodiments, methods of the present disclosure may yield a yellowness index of the decolorized hydrocarbon resin, as measured by ASTM E313, of less than about 30, or less than about 25, or less than about 10, or less than about 5, or less than about 3, or less than about 1. In some embodiments, the noble metal catalyst can decrease a yellowness index by about 80 units or more, by about 100 units or more, by about 120 units or more, or by about 140 units or more, as determined by ASTM E313, upon reacting the hydrogenated resin mixture and forming the decolorized resin mixture.

Embodiments disclosed herein include:
A. Methods for preparing hydrocarbon resins. The methods comprise: reacting a resin mixture in the presence of a sulfided bimetallic catalyst and excess hydrogen under conditions effective to form a hydrogenated resin mixture, the resin mixture comprising an oligomerized reaction product of at least one polymerizable monomer containing an olefinic unsaturation and a solvent; providing the hydrogenated resin mixture directly to a noble metal catalyst; and reacting the hydrogenated resin mixture in the presence of the noble metal catalyst under conditions effective to form a decolorized resin mixture.
B. Decolorized resin compositions. The decolorized resin compositions comprise: a hydrogenated resin mixture formed from an oligomerized reaction product of at least one polymerizable monomer containing an olefinic unsaturation; wherein the hydrogenated resin mixture has a yellowness index of about 10 or below, as measured by ASTM E313.

Embodiments A and B may have one or more of the following additional elements in any combination:
Element 1: wherein the conditions effective to form a hydrogenated resin mixture and the conditions effective to form a decolorized resin mixture comprise a reaction temperature of about 150° C. to about 350° C. and a pressure of about 6 MPa to about 27 MPa.
Element 2: wherein the noble metal catalyst is effective to decrease a yellowness index by about 100 units or more as determined by ASTM E313 upon reacting the hydrogenated resin mixture and forming the decolorized resin mixture.
Element 3: wherein the method further comprises: removing at least a portion of the excess hydrogen and the solvent from the decolorized resin mixture.
Element 4: wherein the method further comprises: processing the decolorized resin mixture into pellets.
Element 5: wherein the resin mixture is prepared under thermal oligomerization conditions.
Element 6: wherein the at least one polymerizable monomer comprises a monomer selected from the group consisting of dicyclopentadiene, methyldicyclopentadiene, styrene, methylstyrene, indene, methylindene, and any combination thereof.
Element 7: wherein the hydrogenated resin mixture is provided directly to the noble metal catalyst without removing sulfur compounds from the hydrogenated resin mixture.
Element 8: wherein the noble metal catalyst comprises a support material.

Element 9: wherein the noble metal catalyst comprises an external noble metal coating upon the support material, and wherein the support material is substantially free of noble metal.
Element 10: wherein the external metal coating has a thickness of about 150 μm or less.
Element 11: wherein the resin mixture contains one or more aromatic moieties and no more than about 20% of the aromatic moieties are hydrogenated in the decolorized resin mixture.
Element 12: wherein the noble metal catalyst comprises palladium.
Element 13: wherein the noble metal catalyst has a palladium loading greater than about 0.1 wt %.
Element 14: wherein the support material comprises an oxide support or a carbon support.
Element 15: wherein the support material comprises a porous carbon.
Element 16: wherein the support material has a surface area of about 3,000 m²/g or less.
Element 17: wherein the support material has a surface area in a range of about 50 m²/g to about 350 m²/g.
Element 18: A decolorized resin composition prepared by the method of A.

Illustrative combinations applicable to A may include, but are not limited to, 1 and 2; 1 and 3; 1 and 4; 1 and 5; 1 and 6; 1 and 7; 1 and 8; 1, 8 and 9; 1 and 8-10; 1 and 11; 1 and 12; 1 and 13; 1, 8 and 14; 1, 8, and 15 or 16; 2 and 3; 2 and 4; 2 and 5; 2 and 6; 2 and 7; 2 and 8; 2, 8 and 9; 2 and 8-10; 2 and 11; 2 and 12; 2 and 13; 2, 8 and 14; 2, 8, and 15 or 16; 3 and 4; 3 and 5; 3 and 6; 3 and 7; 3 and 8; 3, 8 and 9; 3 and 8-10; 3 and 11; 3 and 12; 3 and 13; 3, 8 and 14; 3, 8, and 15 or 16; 4 and 5; 4 and 6; 4 and 7; 4 and 8; 4, 8 and 9; 4 and 8-10; 4 and 11; 4 and 12; 4 and 13; 4, 8 and 14; 4, 8, and 15 or 16; 5 and 6; 5 and 7; 5 and 8; 5, 8 and 9; 5 and 8-10; 5 and 11; 5 and 12; 5 and 13; 5. 8 and 14; 5, 8, and 15 or 16; 6 and 7; 6 and 8; 6, 8 and 9; 6 and 8-10; 6 and 11; 6 and 12; 6 and 13; 6, 8 and 14; 6, 8, and 15 or 16; 7 and 8; 7, 8 and 9; 7 and 8-10; 7 and 11; 7 and 12; 7 and 13; 7, 8 and 14; 7, 8, and 15 or 16; 8 and 9; 8-10; 8-11; 8-10 and 12; 8 and 13; 8-10 and 13; 8 and 14; 8-10 and 14; 8, and 15 or 16; 8-10, and 15 or 16; 11 and 12; 11 and 13; 11 and 14; 11, and 15 or 16; 12 and 13; 12 and 14; 12, and 15 or 16; and 13, and 15 or 16.

To facilitate a better understanding of the disclosure herein, the following examples of various representative embodiments are given. In no way should the following examples be read to limit, or to define, the scope of the present disclosure.

### EXAMPLES

Example 1: Sulfur Tolerance of Pd-Coated Noble Metal Catalysts. In this example, three pilot plant reactors were prepared from ¾″ SCH 40 stainless steel pipe with inlet/outlet fittings and a catalyst support grid. Pre-sulfided NiW catalyst was used in each case. A first reactor (R1), prepared in accordance with the present methods, was filled with 17.9 mL NiW and 17.9 mL Pd-coated noble metal catalyst, and further sulfided. The second reactor (R2) was prepared as a negative control with 17.9 mL NiW catalyst, but no Pd-coated noble metal catalyst, and further sulfided. The third reactor (R3) was prepared as a positive control with 17.9 mL NiW catalyst and 17.9 mL Pd-coated noble metal catalyst, but without additional sulfiding. Also, the catalysts in R3 were reduced under hydrogen at 100° C.

The catalyst beds in each reactor were arranged with the NiW catalyst on the top (front of the reactor) and the Pd-coated noble metal catalyst on the bottom (back of the reactor). Each reactor also included 42.6 mL of crushed SiC as a diluent. A greater diluent concentration was used at the top of the reactor. Nominal catalyst properties are provided in Tables 1 and 2 below.

TABLE 1
NiW Bimetallic Catalyst Nominal Properties (as oxide)

| Property | Value | |
|---|---|---|
| Tungsten Oxide | 22 | wt. % |
| Nickel Oxide | 5 | wt. % |
| Aluminum Oxide | Balance | |
| Surface Area | 190 | m²/g |
| Total Pore Volume | 0.6 | cc/g |

TABLE 2
Pd-Coated Noble Metal Catalyst Nominal Properties

| Property | Value | |
|---|---|---|
| Palladium | 1.0 | wt. % |
| Aluminum Oxide | Balance | |
| Surface Area | 100-240 | m²/g |

The reactors were first conditioned by an “activation” step prior to initiating the hydrogenation reaction. Reactors 1 and 2 were sulfided using hydrogen and a solvent containing 2.5 wt. % dimethyl disulfide (DMDS). The solvent was passed over the catalyst at 35 mL/hr, and the hydrogen flow rate was 7 standard liters per hour (SLPH). The reactor temperature was held at 250° C. for 4 hours, followed by heating to 330° C. at 10° C./hr. The temperature was then maintained at 330° C. for another 4 hours. Hydrogen sulfide was detected coming out of the reactor using an on-line gas chromatograph. The total amount of hydrogen sulfide generated during the sulfiding procedure was approximately 800 times that required to transform Pd(0) into PdS. Reactor 3 was further reduced under flowing hydrogen (2 barg) at 65° C. for 2 hours and at 95° C. for 2 hours.

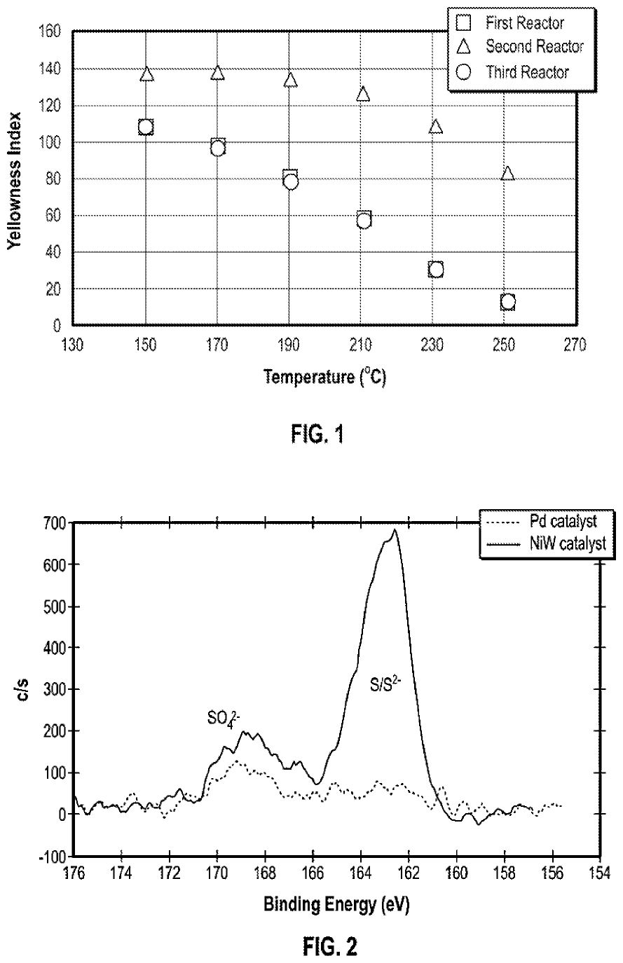

After activation, the reactors were brought to 200° C. and liquid feed and hydrogen were introduced to establish an activity baseline. The liquid feed consisted of 30 wt. % resin and 70% EXXSOL™ solvent, and had a total sulfur content of 250 wppm. Liquid and gas feeds were fed to the catalyst bed in downflow mode. Liquid feed was introduced at 70 mL/hr and hydrogen was added at 11.5 SLPH. After establishing an activity baseline, the reactor temperature was reduced to 150° C., and was then increased from 150° C. to 250° C. in 20° C. increments, and reactor product samples were collected after the reactor stabilized at each temperature. The color of each reactor product was measured directly using a HunterLab™ colorimeter without further purification and plotted as yellowness index (YI) according to ASTM E313 as a function of temperature (FIG. 1). The resulting YI from R1 and positive control R3 (squares and circles, respectively) were very similar, indicating that the Pd-coated noble metal catalyst in R1 was not poisoned with hydrogen sulfide introduced during the sulfidation step. The YI of negative control R2 (triangles), loaded with only 17.9 mL sulfided NiW bimetallic catalyst and 60.4 mL of SiC diluent, exhibited comparatively higher YI values over R1 and R3 throughout the range of temperatures tested. The results show that the sulfided Pd-coated noble metal catalyst (R1) has the same outlet YI as the properly activated Pd-coated noble metal catalyst (R3). Thus, the Pd-coated noble metal catalyst is either not substantially poisoned by sulfiding, or catalytic activity is substantially recovered after removing the source of sulfur.

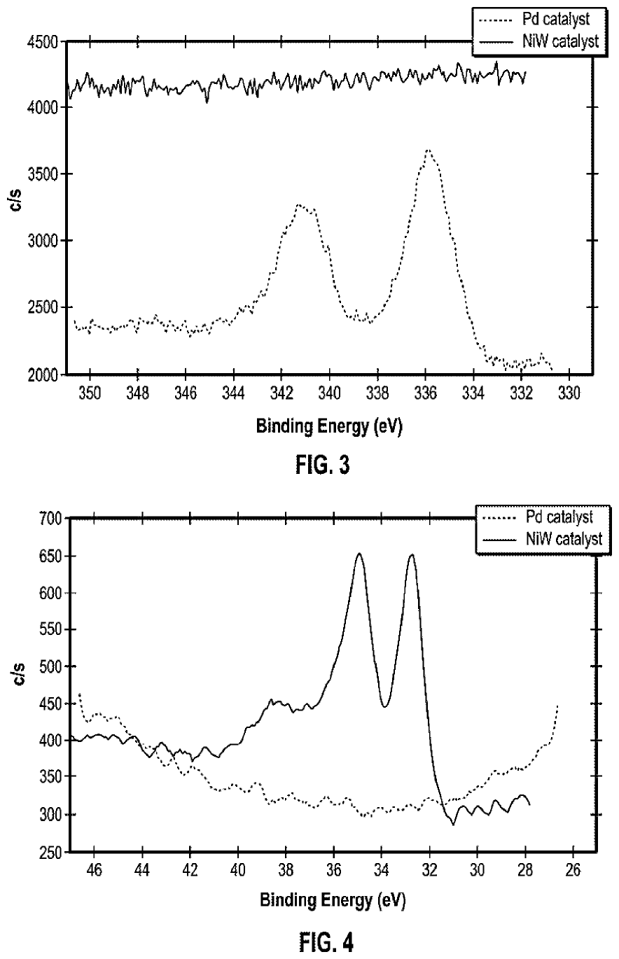

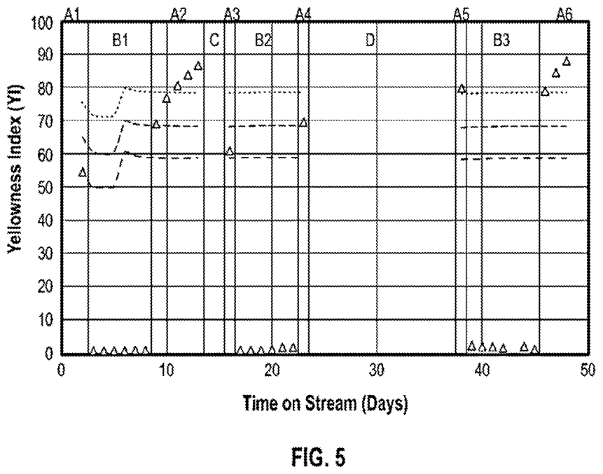

Following the experiment, “spent” NiW catalyst and Pd-coated noble metal catalyst from R1 were collected under a nitrogen blanket and analyzed by x-ray photoelectron spectroscopy (XPS) using a ULVAC-PHI Quantera II XPS. Data is shown in FIGS. 2-4. The XPS spectrum of FIG. 2 highlights the sulfur (S) region for the NiW catalyst and the Pd-coated noble metal catalyst. No metallic sulfide (S²⁻) was observed for the Pd-coated noble metal catalyst, even where the bimetallic NiW catalyst exhibits peaks for sulfate and sulfide. With respect to FIG. 3, analysis of the Pd region for the same catalysts showed no Pd contamination in the bimetallic catalyst. Similarly, no W contamination of the Pd-coated noble metal catalyst was observed when analyzing the W region of the XPS spectrum, as shown in FIG. 4. These results were also confirmed by the quantitative data shown in Table 3. All sulfur detected in spent Pd-coated noble metal catalyst sample was in the form of sulfate (SO₄²⁻). Any sulfur present in the form of PdS was below the instrument detection limit. In summary, XPS measurements confirmed that the Pd(0) was not substantially (or at least not irreversibly) converted to PdS, and no permanent change in activity was observed over the time scale tested.

TABLE 3

| Catalyst Sample | S, Atomic % | Pd, Atomic % | W, Atomic % |
|---|---|---|---|
| Pd/Alumina | 0.07 | 0.73 | 0 |
| NiW/Alumina | 1.88 | 0 | 0.14 |

Example 2: Long-Term Sulfur Tolerance of Pd-Coated Noble Metal Catalysts. A reactor of similar geometry to those used in Example 1 was loaded with 26.8 mL of pre-sulfided NiW bimetallic catalyst, 9.0 mL of Pd-coated noble metal catalyst (75:25 ratio), and 42.5 mL of SiC diluent. Like Example 1, the pre-sulfided NiW catalyst was loaded on the top/front of the reactor and the Pd-coated noble metal catalyst was loaded at the bottom/back of the reactor. The reactor was reduced under hydrogen using the same reduction conditions as R3 in Example 1.

A hydrocarbon resin mixture feed containing 30 wt. % resin in solvent and a total of 250 wppm sulfur was introduced to the reactor in downflow mode at 70 mL/hr (liquid hourly space velocity=2.0 hr⁻¹). Samples were collected from the reactor output, and the raw YI as function of time was determined, as shown in FIG. 5 (triangles). The dashed lines shown in FIG. represent the following with respect to the expected catalyst activity: 130% of expected catalyst activity (dashed), 100% of expected catalyst activity (dot-dashed), and 70% of expected catalyst activity (dotted), assuming all activity differences are associated entirely with the Pd-coated noble metal catalyst. All dashed lines are predicted based on expected catalyst activity at 200° C., and cannot be readily compared with yellowness index values measured at different temperatures (regions marked B1, B2, or B3 in FIG. 5).

The reactor temperature was cycled between long holds at 280° C. (labelled B1-B3 in FIG. 5) and short activity checks at 200° C. (labeled A1-A6). As shown, catalyst activity within the range of expected values was realized. A hot hydrogen strip at 330° C. with solvent and hydrogen is labeled C in FIG. 5, and a long equipment shutdown for maintenance is labeled D.

The initial activity check immediately after catalyst reduction (A1) showed that the resulting YI was better than expected, corresponding to approximately 130% of the expected catalyst activity. Region B1 corresponds to a 6-day hold at 280° C. This temperature is hot enough to convert the sulfur in the feed into hydrogen sulfide, and every day at this process condition exposed the Pd-coated noble metal catalyst to 3 times the hydrogen sulfide required to fully oxidize the Pd(0) into PdS. Therefore, the 6-day hold provided 18 times the hydrogen sulfide theoretically required to poison the catalyst fully. The activity check after this hold (A2) showed that the catalyst retained the expected activity, even after being exposed to such high amounts of hydrogen sulfide. In period A2, the temperature was held at 200° C. for 5 days, and the product YI increased steadily, indicating an increasing loss of catalyst activity at this temperature. No hydrogen sulfide was detected at 200° C. by gas chromatography testing on the reactor effluent gas, since the catalysts do not convert sulfur-containing compounds to hydrogen sulfide at this temperature. This result suggests that the deactivation mechanism is related to physical adsorption of high molecular weight species on the active sites of the catalyst.

The reactor was then subjected to a hot hydrogen strip in the period labeled C, which recovered the catalyst activity. After the hot hydrogen strip (period C in FIG. 5), resin and solvent were added to the reactor again and heated to 200° C. to check activity (period A3 in FIG. 5). Again, the catalyst activity was near 130%, indicating that there was inconsequential permanent activity loss across the temperature hold and the activity check. During another 6-day hold at 280° C. (B2), the catalyst was exposed to another 18 times the concentration of hydrogen sulfide expected to result in full poisoning. The post-hold activity check (A4) showed that the catalyst activity again returned to 100% of the expected value. Thus, the Pd-coated noble metal catalyst maintained activity, despite being exposed to a cumulative amount of hydrogen sulfide 36 times that theoretically required to poison the catalyst fully.

The reactor was then shut down for maintenance for a 14 day period (period D in FIG. 5). During shutdown, the reactor was flushed with solvent, dried, and stored under nitrogen at ambient temperature during the shutdown period. The reactor was restarted and another activity check was performed in period A5, which showed a lower activity than previous activity check A4. The catalyst was not exposed to any additional hydrogen sulfide or resin during the shutdown, and the loss of activity during the shutdown was determined to result from incomplete catalyst wetting upon restarting the reactor.

A third high temperature hold at 280° C. was performed for 7 days in period B3, during which the catalyst was exposed to an additional 21 times the hydrogen sulfide required to affect complete poisoning. A final 200° C. activity check (A6) provided an initial activity approximately the same as the pre-hold activity check (A5), suggesting that no appreciable catalyst deactivation occurred during the hold. As before, the hold at 200° C. showed partial catalyst deactivation over time at this temperature (A6).

Overall, the Pd-coated noble metal catalyst was exposed to enough hydrogen sulfide to fully poison it 57 times, but no deactivation below the expected value was observed (holds B1 and B2), or no deactivation occurred upon exposure to hydrogen sulfide (hold B3). If the Pd-coated noble metal catalyst had been poisoned by the hydrogen sulfide, the YI at the reactor outlet would have been >95, even if the sulfided NiW bimetallic catalyst maintained 100% activity.

Reactor effluent YI>95 was not observed under any circumstances.

Example 3: Conversion Properties as a Function of Temperature. In this example, a pilot plant scale run was performed using a reactor having a reactor bed loaded with 1:1 (by volume) pre-sulfided NiW catalyst:Pd-coated noble metal catalyst. 25 mL of each catalyst was used, along with 100 mL SiC diluent. During operation, several variables were monitored including: a) YI as a function of reactor temperature, b) aromatics saturation as a function of reactor temperature, and c) color conversion as a function of aromatics saturation.

Samples containing resin dissolved in solvent at 30 wt. % concentration werepassed over the catalyst bed in downflow mode at a space velocity of 2.0 hr⁻¹ and a gas ratio of 150. During testing, the reactor temperature was increased from 200° C. to 300° C. in 20° C. increments.

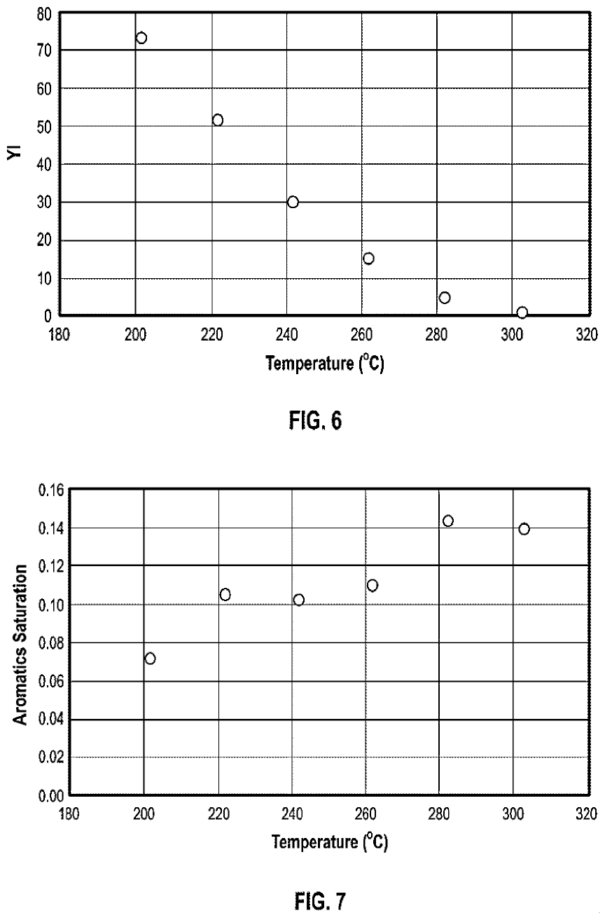

FIG. 6 is a graph of YI as a function of temperature of the run. The feed had an initial YI of 137.8 and was decreased to a final YI of 0.9 at 300° C., which is equivalent to a reduction of 136.9 YI units. Accordingly, greater than 99% of the initial color was removed upon reaching 300° C.

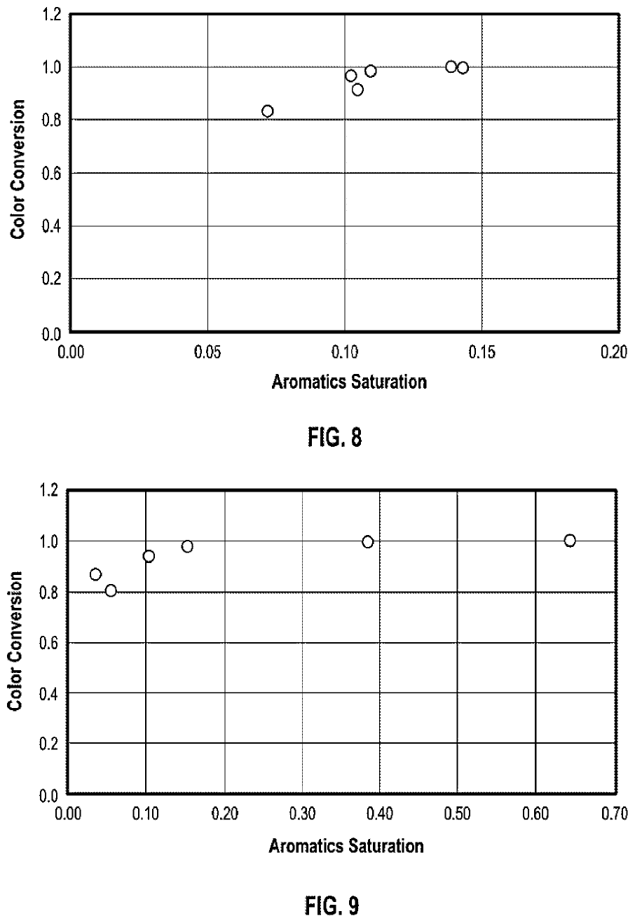

FIG. 7 is a graph of aromatics saturation (conversion) as a function of temperature for the run. Aromatics saturation was determined by ¹H NMR. In the samples surveyed, the aromatics saturation was less than that obtained from a comparative sulfided NiW catalyst alone, which gives approximately 30% aromatics saturation (data not shown). The baseline aromatics saturation of ˜5% is believed to be an artifact of the ¹H NMR measurement technique. In particular, since olefin saturation increases both aliphatic hydrogen and total hydrogen in the reaction product while the number of aromatic protons remains constant, the ratio of aromatic protons to aliphatic protons decreases. Thus, even if no aromaticity loss has taken place, a decreased ratio of aromatic:aliphatic protons is observed, thereby leading to the small amount of reported baseline aromatics saturation. Between 220° C. and 260° C., the aromatics saturation ranged from 10-12%. Between 280° C. and 300° C., the aromatics saturation was slightly higher at 12-14%. Thus, depending on the extent of coloration that can be tolerated, the aromatics saturation may be varied to some extent by running the reactor at lower temperatures. FIG. 8 is a graph of color conversion as a function of aromatics saturation for the run. As shown, high color conversion (80+%) was obtained with relatively low aromatics sauration (<15%).

A comparative run was also performed using a conventional porous Pt/Pd catalyst in place of the Pd-coated noble metal catalyst. The other reaction parameters were the same as in the other sample runs. Color conversion as a function of aromatics saturation was measured for comparison with the data shown in FIG. 8. FIG. 9 is a graph of color conversion as a function of aromatics saturation for a comparative sample decolorized with a porous Pt/Pd catalyst. As shown in FIG. 9, aromatics saturation was 40% or above for samples reaching the highest extent of decoloration. Thus, the Pd-coated noble metal catalyst may lessen aromatics saturation while still achieving significant decoloration. Additional variation may be realized by changing the amount of Pd-coated noble metal catalyst present.

Example 4: Additional Performance Data. In this example, improved resin color was obtained upon hydrogenation over a fixed bed of 75 vol. % pre-sulfided NiW catalyst and 25 vol. % Pd-coated noble metal catalyst layered upon the NiW catalyst (i.e., in the tail position of the fixed bed). The catalysts are equivalent to those specified in Tables 1 and 2 (Example 1). A second reactor was independently run in parallel under similar conditions for comparison, except utilizing only pre-sulfided NiW catalyst. Each reactor was approximately 100 mL in volume, and made of a 0.75″ O.D.×0.516″ I.D. 316 stainless steel tube having a 30″ length. Each reactor bed was loaded with ˜90 mL of catalyst. Process feeds were supplied to the catalyst bed in upflow mode.

Catalyst performance during resin hydrogenation was assessed under the following conditions: pressure ˜2,800 psig; and isothermal reactor temperature of 400° F. (˜204° C.) to 620° F. (˜327° C.). A solvent flush was carried out at indicated times using VARSOL™ 1 (ExxonMobil) at 90 mL/hr (or 1 hr⁻¹ LHSV). The hydrocarbon feed compositions for various portions of the runs are specified in Table 4 below.

TABLE 4
Liquid Hydrocarbon Feed Composition

| Feed Type | Solvent wt. % | Resin wt. % |
|---|---|---|
| Cyclic Resin #1 | 84 | 16 |
| Cyclic Resin #2 | 68 | 32 |
| Aromatic Resin | 68 | 32 |

The test condition sequence are specified in Tables 5 and 6 below for each reactor. The liquid feed flow rate was set at 135 mL/hr (or 1.5 hr⁻¹ LHSV), and the hydrogen flow rate was set at 20.25 SLPH (or 150 Gas/Liquid Ratio), or 27.00 SLPH (or 200 Gas/Liquid Ratio). The total run time was about 46 days.

TABLE 5
Test Condition Summary Table
NiW/Pellicular Pd

| | Time on | | | | |
|---|---|---|---|---|---|
| | Stream | | Resin | | Gas |
| T (° C.) | [TOS] (hr) | Resin Grade/Other | Wt. % | VVH | Ratio |
| 270-310 | 0-120 | Cyclic Resin #1 | 16 | 1.5 | 150 |
| 270-320 | 144-240 | Aromatic Resin | 32 | 1.5 | 150 |
| 270 | 248 | H₂ + VARSOL ™ 1/ | | | 150 |
| | | Hydrogen Treat | | | |
| 270 | 312-336 | Cyclic Resin #2 | 32 | 1.5 | 150 |
| | 384 | VARSOL ™ 1 Flush | | 1.5 | 150 |
| 290 | 408 | Cyclic Resin #2 | 32 | 1.5 | 150 |
| 270 | 416 | Hydrogen Treat | | 1.5 | 150 |
| 270-310 | 432-528 | Cyclic Resin #2 | 32 | 1.5 | 150 |
| 270-320 | 552-1104 | Aromatic Resin | 32 | 1.5 | 150 |

TABLE 6
Test Condition Summary Table
NiW (Comparative)

| | Time on | | | | |
|---|---|---|---|---|---|
| | Stream | | Resin | | Gas |
| T (° C.) | [TOS] (hr) | Resin Grade/Other | Wt. % | VVH | Ratio |
| 270-310 | 0-120 | Cyclic Resin #1 | 16 | 1.5 | 150 |
| 270-320 | 144-240 | Aromatic Resin | 32 | 1.5 | 150 |
| 270 | 248 | H₂ + VARSOL ™ 1/ | | | 150 |
| | | Hydrogen Treat | | | |
| 270 | 312-336 | Cyclic Resin #2 | 32 | 1.5 | 150 |
| | 384 | VARSOL ™ 1 Flush | | 1.5 | 150 |
| 290-330 | 408-432 | Cyclic Resin #2 | 32 | 1.5 | 150 |
| 270-320 | 480-1104 | Aromatic Resin | 32 | 1.5 | 150 |

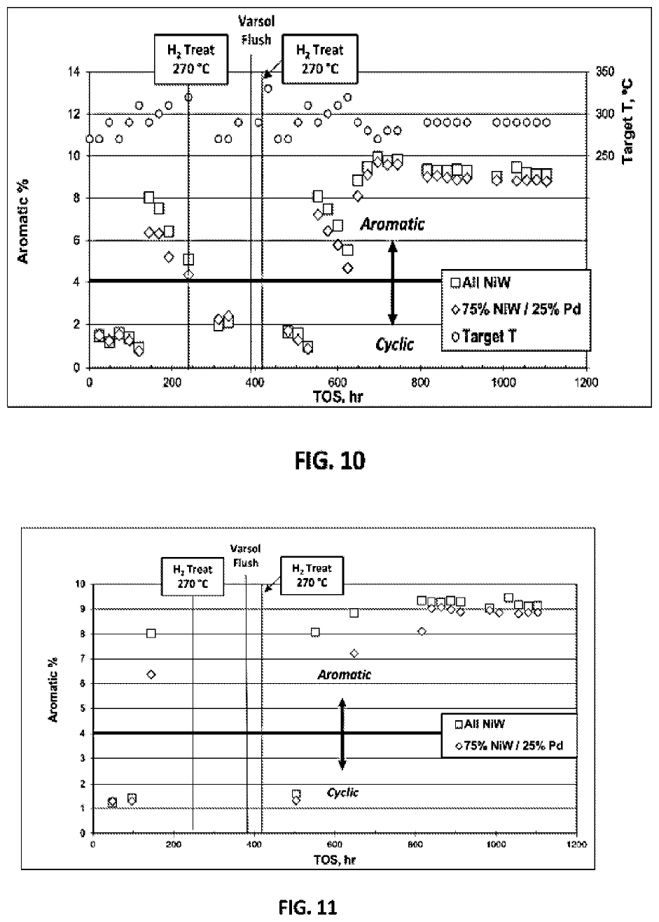

The first property studied was the aromatic content of the hydrogenated resin. FIG. 10 is a graph of aromatic content as a function of time on stream for experimental and comparative samples. Aromatic content was determined by measuring percent aromatic protons by ¹H NMR. FIG. 11 is a corresponding graph showing only the data obtained at 290° C. As shown, hydrogen treatments were conducted at 248 and 416 hours, and a solvent flush was conducted at 384 hours. No performance degradation, as measured by aromatics content or other performance property, resulted from the hydrogen treatments or solvent flush.

For cyclic grade resins, the two parallel reactors afforded no significant difference in aromatic content. For aromatic grade resins, the comparative reactor containing only pre-sulfided NiW catalyst afforded a slightly higher aromatic content than did the experimental reactor, but the performance difference decreased considerably over time.

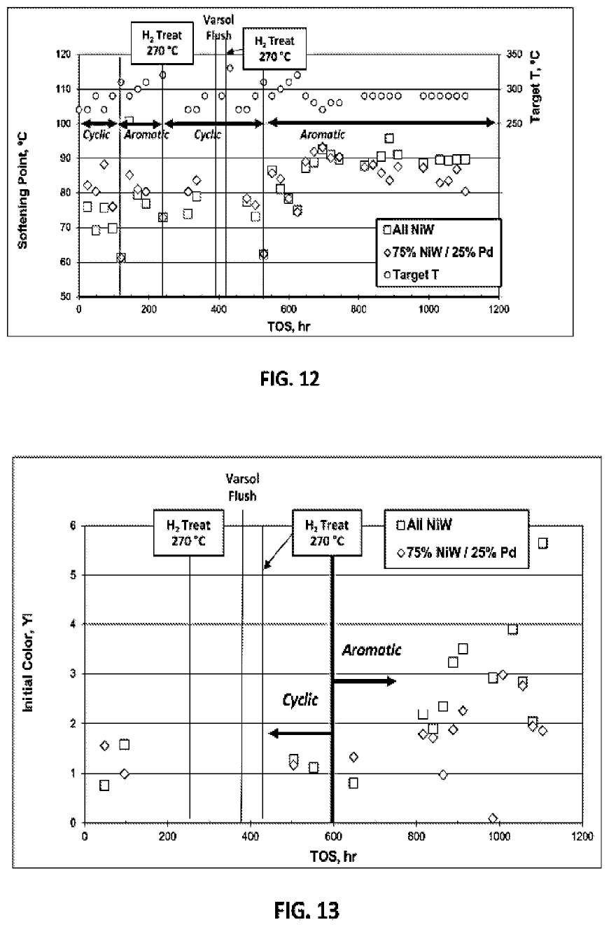

Softening points of the hydrogenated resins were also evaluated. FIG. 12 is a graph of softening point of the hydrogenated resin as a function of time on stream for experimental and comparative samples. Softening points were determined after steam stripping to remove solvent. Similar softening points were obtained in both cases.

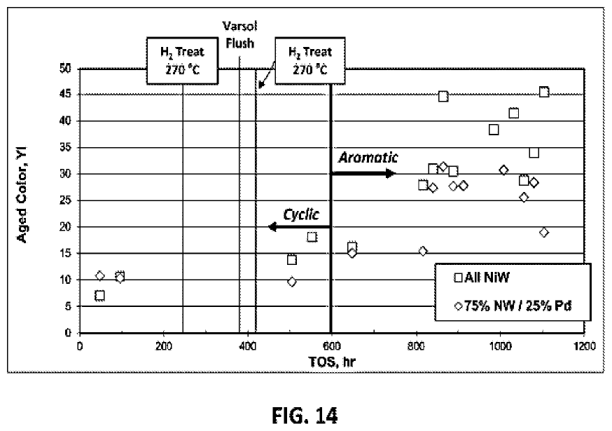

FIG. 13 is a graph of initial color (as yellowness index) as a function of time on stream for experimental and comparative samples for data obtained at 290° C. FIG. 14 is a corresponding graph of aged color (as yellowness index) as a function of time on stream. Aged color may be determined by heating the hydrogenated product in a jar, exposed to air, over a hold time of 5 hours. As shown, the experimental samples produced from aromatic resin exhibited a lower coloration than did the samples obtained from the comparative reactor. There was minimal color difference for the cyclic resin samples. Thus, by using a Pd-coated noble metal catalyst, significant decoloration may be realized while still retaining significant aromaticity.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed, including the lower limit and upper limit. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is:

1. A method for preparing hydrocarbon resins comprising:
reacting a resin mixture with a sulfided bimetallic catalyst and excess hydrogen under conditions effective to form a hydrogenated resin mixture, the resin mixture comprising an oligomerized reaction product of at least one polymerizable monomer containing an olefinic unsaturation and a solvent;
providing the hydrogenated resin mixture directly to a noble metal catalyst; and
reacting the hydrogenated resin mixture in the presence of the noble metal catalyst under conditions effective to form a decolorized resin mixture.

2. The method of claim 1, wherein the conditions effective to form a hydrogenated resin mixture and the conditions effective to form a decolorized resin mixture comprise a reaction temperature of about 150° C. to about 350° C. and a pressure of about 6 MPa to about 27 MPa.

3. The method of claim 1, wherein the noble metal catalyst is effective to decrease a yellowness index by about 100 units or more as determined by ASTM E313 upon reacting the hydrogenated resin mixture and forming the decolorized resin mixture.

4. The method of claim 1, further comprising:
removing at least a portion of the excess hydrogen and the solvent from the decolorized resin mixture.

5. The method of claim 1, further comprising:
processing the decolorized resin mixture into pellets.

6. The method of claim 1, wherein the resin mixture is prepared under thermal oligomerization conditions.

7. The method of claim 1, wherein the at least one polymerizable monomer comprises a monomer selected from the group consisting of dicyclopentadiene, methyldicyclopentadiene, styrene, methylstyrene, indene, methylindene, and any combination thereof.

8. The method of claim 1, wherein the hydrogenated resin mixture is provided directly to the noble metal catalyst without removing sulfur compounds from the hydrogenated resin mixture.

9. The method of claim 1, wherein the noble metal catalyst comprises a support material.

10. The method of claim 9, wherein the noble metal catalyst comprises an external noble metal coating upon the support material, and wherein the pores of the support material are substantially free of noble metal.

11. The method of claim 10, wherein the external metal coating has a thickness of about 150 μm or less.

12. The method of claim 1, wherein the resin mixture contains one or more aromatic moieties and no more than about 20% of the aromatic moieties are hydrogenated in the decolorized resin mixture.

13. The method of claim 1, wherein the noble metal catalyst comprises palladium.

14. The method of claim 13, wherein the noble metal catalyst has a palladium loading greater than about 0.1 wt. %.

15. The method of claim 9, wherein the support material comprises an oxide support or a carbon support.

16. The method of claim 9, wherein the support material comprises a porous carbon.

17. The method of claim 9, wherein the support material has a surface area of about 3,000 m²/g or less.

18. The method of claim 17, wherein the support material has a surface area in a range of about 50 m²/g to about 350 m²/g.

19. A decolorized resin composition prepared by the method of claim 1.

20. A decolorized resin composition comprising:
a hydrogenated resin mixture formed from an oligomerized reaction product of at least one polymerizable monomer containing an olefinic unsaturation;
wherein the hydrogenated resin mixture has a yellowness index of about 10 or below, as measured by ASTM E313.
